(19) United States
(12) Patent Application Publication
(10) Pub. No.: US 2007/0071920 A1
(43) Pub. Date: Mar. 29, 2007

(54) Heat exchanger tube and heat exchanger

(75) Inventors: Ken Muto, Toyota-city (JP); Hiroki Matsuo, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/524,768

(22) Filed: Sep. 21, 2006

(30) Foreign Application Priority Data
Sep. 29, 2005 (JP) 2005-284949

(51) Int. Cl. B28B 11/00

(52) U.S. Cl. 428/34.4

(57) ABSTRACT

A heat exchanger tube improved in endurance to chipping, while securing performance, by changing the tube specifications, wherein, for example, fluid circulating holes are formed to be substantially rectangular in cross-section, and, when a width direction thickness of a front side wall part of the tube is “T” and a thickness of partition wall parts “A”, the relationship 3.1≦T/A≦6.1 is made to stand by the shaping process. According to this, in a rectangular hole tube, it is possible to change the dimensional relationship of the tube while securing performance so as to improve the endurance to chipping from the front frontal direction to 150 km/h (the conventional endurance being 100 km/h, a ratio to the conventional value of 1.5).

### BACKGROUND OF THE INVENTION

1. Field of the Invention

The present invention relates to an aluminum or other metal heat exchanger tube and a heat exchanger using this tube, more particularly ones suitable for use for a condenser in a car air-conditioner etc.

2. Description of the Related Art

Normally, a condenser of car air-conditioning system is arranged outside of the passenger compartment at the front end of the vehicle. The chipping etc. during driving easily deforms or damages the front surfaces of the heat exchanger tubes. Further, during vehicle operation, the tubes are exposed to rainwater, mud, exhaust gas, refuse, etc. blown into the chassis from outside. These become causes of condenser corrosion. In particular, corrosion is liable to occur starting from the deformed or damaged parts. The tubes therefore become corroded. If the corrosion progresses and holes form in the tubes, there is the problem of leakage of refrigerant.

As conventional art against this chipping, there are Japanese Patent No. 2558542, Japanese Patent Publication (A) No. 11-44498, Japanese Patent Publication (A) No. 2002-181463, etc. Japanese Patent No. 2558542 discloses to make only the front surface parts of the tubes thicker. Japanese Patent Publication (A) No. 11-44498 discloses to make only the passages at the side ends of the tubes round holes. Japanese Patent Publication (A) No. 2002-181463 discloses arranging the joined ends of the plate-shaped tubes at the upwind side.

However, in recent years, along with the reduction in size of engine compartments, condensers are being placed near the grille openings or, to secure heat dissipation, the areas of front openings of the vehicles are being increased. Due to this, the condensers mounted at the front ends of the vehicles are becoming more vulnerable to pebbles or other flying objects. On the other hand, condensers and other heat exchangers are being made out of thinner parts in order to improve the heat radiating performance and reduce costs.

### SUMMARY OF THE INVENTION

As a result, there is the problem that leakage of refrigerant due to impact form flying objects is becoming more likely to occur. The present invention was made in consideration of this conventional problem and has as its object the provision of a heat exchanger tube and heat exchanger able to secure the required performance and simultaneously improve the endurance to chipping by a change in specifications of the tube.

The present invention achieves the above object by employing the technical means described in the first aspect to the 16th aspect of the invention. That is, in a first aspect of the invention, there is provided a heat exchanger tube comprising a flat shaped tube sectioned off inside by partition wall parts (22) spanning flat wall parts (21) arranged facing each other to form peripheral walls of the tube, a plurality of fluid circulating holes (23) running in a longitudinal direction being arranged in parallel in the width direction, air flowing along the outside of the tube in the substantially width direction of the tube and fluid running through the fluid circulating holes (23) exchanging heat, wherein the fluid circulating holes (23) are formed to be substantially rectangular in cross-section and, when a width direction thickness of a front side wall part (24) of the tube is “T” and a thickness of the partition wall parts (22) is “A”, the relationship 3.1≦T/A≦6.1 is made to stand by the shaping process.

According to the first aspect of the invention, in a substantially rectangular hole tube, it is possible to change the dimensional relationship of the tube while securing performance so as to improve the endurance to chipping from the front frontal direction to 150 km/h (the conventional endurance being 100 km/h, a ratio to the conventional value of 1.5).

Further, in a second aspect of the invention, there is provided a heat exchanger tube similar to the first aspect, but wherein the fluid circulating holes (23) are formed to be substantially circular in cross-section, and, when a width direction thickness of a front side wall part (24) of the tube is “T” and a thickness of the partition wall parts (22) is “A”, the relationship 4.4≦T/A≦8.5 is made to stand by the shaping process.

According to the second aspect of the invention, in a circular hole tube, it is possible to change the dimensional relationship of the tube while securing performance so as to improve the endurance to chipping from the front frontal direction to 150 km/h (the conventional endurance being 100 km/h, a ratio to the conventional value of 1.5).

Further, in a third aspect of the invention, there is provided a heat exchanger tube similar to the first aspect, but wherein when a width direction thickness of a front side wall part (24) of the tube is “T” and the thickness of the flat wall parts (21) is “B”, the relationship 2.9≦T/B≦5.6 is made to stand by the shaping process.

According to the third aspect of the invention, it is possible to change the dimensional relationship of the tube while securing performance and corrosion resistance so as to improve the endurance to chipping from the front frontal direction to 150 km/h (the conventional endurance being 100 km/h, a ratio to the conventional value of 1.5).

Further, in a fourth aspect of the invention, there is provided a heat exchanger tube similar to the first aspect, wherein the fluid circulating holes (23) are formed to be substantially rectangular in cross-section and, when a thickness in a downward inclined direction of a front side wall part (24) of the tube is “Ta” and a thickness of the partition wall parts (22) is “A”, the relation 2.8≦Ta/A≦5.3 is made to stand by the shaping process.

According to the fourth aspect of the invention, in a substantially rectangular hole tube, it is possible to change the dimensional relationship of the tube while securing performance so as to improve the endurance to chipping from the front downward direction to 150 km/h (the conventional endurance being 100 km/h, a ratio to the conventional value of 1.5).

Further, in a fifth aspect of the invention, there is provided a heat exchanger tube similar to the first aspect, wherein the fluid circulating holes (23) are formed to be substantially circular in cross-section and, when a thickness in a downward inclined direction of a front side wall part (24) of the tube is “Ta” and a thickness of the partition wall parts (22) is “A”, the relationship 3.8≦Ta/A≦7.1 is made to stand by the shaping process.

According to the fifth aspect of the invention, in a circular hole tube, it is possible to change the dimensional relationship of the tube while securing performance so as to improve the endurance to chipping from the front downward direction to 150 km/h (the conventional endurance being 100 km/h, a ratio to the conventional value of 1.5).

Further, in a sixth aspect of the invention, there is provided a heat exchanger tube similar to the first aspect, wherein when a thickness in a downward inclined direction of a front side wall part (24) of the tube is “Ta” and the thickness of the flat wall parts (21) is “B”, the relationship 2.5≦Ta/B≦4.7 is made to stand by the shaping process.

According to the sixth aspect of the invention, it is possible to change the dimensional relationship of the tube while securing performance and corrosion resistance so as to improve the endurance to chipping from the front downward direction to 150 km/h (the conventional endurance being 100 km/h, a ratio to the conventional value of 1.5).

Further, in a seventh aspect of the invention, there is provided a heat exchanger tube as set forth in the first aspect, wherein when a width direction thickness of a front side wall part (24) is “T” and a thickness of the partition wall parts (22) is “A”, the relationship 3.8≦T/A≦6.1 is made to stand by the shaping process.

According to the seventh aspect of the invention, in a substantially rectangular hole tube, it is possible to change the dimensional relationship of the tube while securing performance so as to improve the endurance to chipping from the front frontal direction to 180 km/h (a further 1.2 times the first aspect of the invention, the conventional endurance being 100 km/h, a ratio to the conventional value of 1.8).

Further, in an eighth aspect of the invention, there is provided a heat exchanger tube as set forth in the second aspect, wherein when a width direction thickness of a front side wall part (24) is “T” and a thickness of the partition wall parts (22) is “A”, the relationship 5.3≦T/A≦8.5 is made to stand by the shaping process.

According to the eighth aspect of the invention, in a circular hole tube, it is possible to change the dimensional relationship of the tube while securing performance so as to improve the endurance to chipping from the front frontal direction to 180 km/h (a further 1.2 times the second aspect of the invention, the conventional endurance being 100 km/h, a ratio to the conventional value of 1.8).

Further, in a ninth aspect of the invention, there is provided a heat exchanger tube as set forth in the third aspect, wherein when a width direction thickness of a front side wall part (24) is “T” and the thickness of the flat wall parts (21) is “B”, the relationship 3.5≦T/B≦5.6 is made to stand by the shaping process.

According to the ninth aspect of the invention, it is possible to change the dimensional relationship of the tube while securing performance and corrosion resistance so as to improve the endurance to chipping from the front frontal direction to 180 km/h (a further 1.2 times the third aspect of the invention, the conventional endurance being 100 km/h, a ratio to the conventional value of 1.8).

Further, in a 10th aspect of the invention, there is provided a heat exchanger tube as set forth in the fourth aspect, wherein when a downward inclined direction thickness of a front side wall part (24) is “Ta” and a thickness of the partition wall parts (22) is “A”, the relationship 3.4≦Ta/A≦5.3 is made to stand by the shaping process.

According to the 10th aspect of the invention, in a substantially rectangular hole tube, it is possible to change the dimensional relationship of the tube while securing performance so as to improve the endurance to chipping from the front downward direction to 180 km/h (a further 1.2 times the fourth aspect of the invention, the conventional endurance being 100 km/h, a ratio to the conventional value of 1.8).

Further, in an 11th aspect of the invention, there is provided a heat exchanger tube as set forth in the fifth aspect, wherein when a downward inclined direction thickness of a front side wall part (24) is “Ta” and a thickness of the partition wall parts (22) is “A”, the relationship 4.5≦Ta/A≦7.1 is made to stand by the shaping process.

According to the 11th aspect of the invention, in a circular hole tube, it is possible to change the dimensional relationship of the tube while securing performance so as to improve the endurance to chipping from the front downward direction to 180 km/h (a further 1.2 times the fifth aspect of the invention, the conventional endurance being 100 km/h, a ratio to the conventional value of 1.8).

Further, in a 12th aspect of the invention, there is provided a heat exchanger tube as set forth in the sixth aspect, wherein when a downward inclined direction thickness of a front side wall part (24) is “Ta” and thickness of the flat wall parts (21) is “B”, the relationship 3.0≦Ta/B≦4.7 is made to stand by the shaping process.

According to the 12th aspect of the invention, it is possible to change the dimensional relationship of the tube while securing performance and corrosion resistance so as to improve the endurance to chipping from the front downward direction to 180 km/h (a further 1.2 times the sixth aspect of the invention, the conventional endurance being 100 km/h, a ratio to the conventional value of 1.8).

Further, in a 13th aspect of the invention, there is provided a heat exchanger tube as set forth in any of the first aspect to 12th aspect, wherein the thickness “A” of the partition wall parts (22) is changed to successively become smaller from the two ends in the width direction toward the inside. Further, in a 14th aspect of the invention, there is provided a heat exchanger tube as set forth in any of the first aspect to 12th aspect wherein the fluid circulating holes (23) have a width direction hole width or hole diameter changed to successively become smaller from the two ends in the width direction toward the inside.

According to the 13th aspect or the 14th aspect of the invention, when extruding this flat multiflow tube, the improvement in rigidity of the comb teeth leads to a prolongation of the life of the multiflow tube extrusion die and prevents deformation in the comb teeth and thereby enables a multiflow tube satisfactory in required dimensions and precision to be obtained.

Further, in a 15th aspect of the invention, there is provided a heat exchanger tube as set forth in any of the first aspect to 14th aspect wherein a projection (24a) is formed at the bottom part of the front side wall part (24). According to the 15th aspect of the invention, it is possible to change the tube end shape and dimensional relationship while securing performance so as to improve the endurance to chipping from the front downward direction.

Further, in a 16th aspect of the invention, there is provided a heat exchanger using heat exchanger tubes (2) as set forth in any of the first aspect to the 15th aspect stacked in the thickness direction and mounted near a front end face of a vehicle. According to the 16th aspect of the invention, it is possible to change the tube end shape and dimensional relationship while securing performance so as to provide a heat exchanger improved in the endurance to chipping from the front direction. Incidentally, the reference numerals in parentheses after the above means are examples showing the correspondence with the specific means described in the later explained embodiment.

### BRIEF DESCRIPTION OF THE DRAWINGS

The present invention may be more fully understood from the description of the preferred embodiments of the invention set forth below together with the accompanying drawings, in which

FIG. 1 is a front view of a heat exchanger 1 according to an embodiment of the present invention;

FIG. 2 is a perspective view showing heat exchanger tubes 2 and a header 5 in the heat exchanger 1 of FIG. 1 disconnected;

FIG. 3 is an end view of a heat exchanger tube 2 according to an embodiment of the present invention of a rectangular hole type,

FIG. 4 is an end view of a heat exchanger tube 2 according to an embodiment of the present invention of a circular hole type,

FIG. 5 is a graph showing the relationship of the chipping strength to T/A,

FIG. 6 is a graph showing the relationship of performance to T/A,

FIG. 7 is a graph showing the relationship of the chipping strength to T/B,

FIG. 8 is a graph showing the relationship of performance to T/B,

FIG. 9 is an explanatory view of a front end thickness Ta in the case envisioning collision from 45 degrees below,

FIG. 10 is a graph showing the relationship of the chipping strength to Ta/A,

FIG. 11 is a graph showing the relationship of performance to Ta/A,

FIG. 12 is a graph showing the relationship of the chipping strength to Ta/B,

FIG. 13 is a graph showing the relationship of performance to Ta/B,

FIG. 14 is a graph showing the relationship of the chipping strength to T/A,

FIG. 15 is a graph showing the relationship of the chipping strength to T/B,

FIG. 16 is a graph showing the relationship of the chipping strength to Ta/A,

FIG. 17 is a graph showing the relationship of the chipping strength to Ta/B,

FIG. 18 is an end view of a heat exchanger tube 2 according to a second embodiment of the present invention,

FIG. 19 is a partial end view of a heat exchanger tube 2 in a third embodiment of the present invention, and

FIGS. 20A, 20B, and 20C are end views of modifications of the heat exchanger tube 2 of the present invention, wherein FIG. 20A shows a triangular hole type, FIG. 20B shows a joined plate type, and FIG. 20C shows a type intermediate between a rectangular hole type and circular hole type.

### BEST MODE FOR WORKING THE INVENTION

### First Embodiment and Second Embodiment

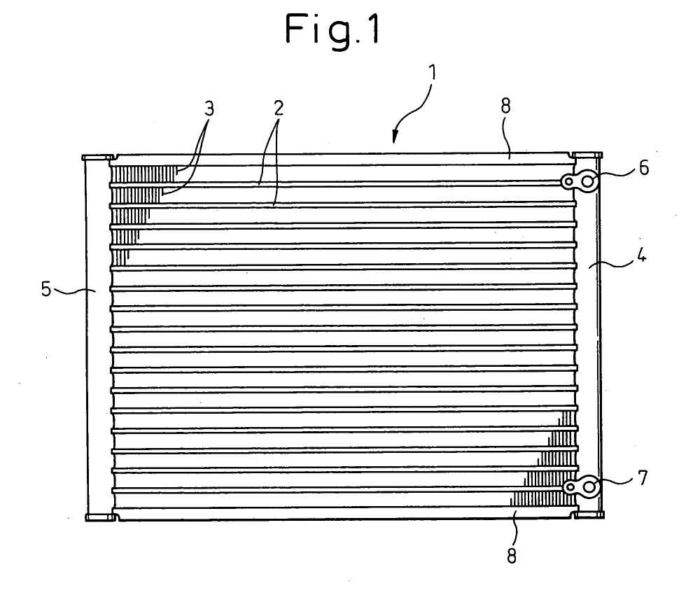

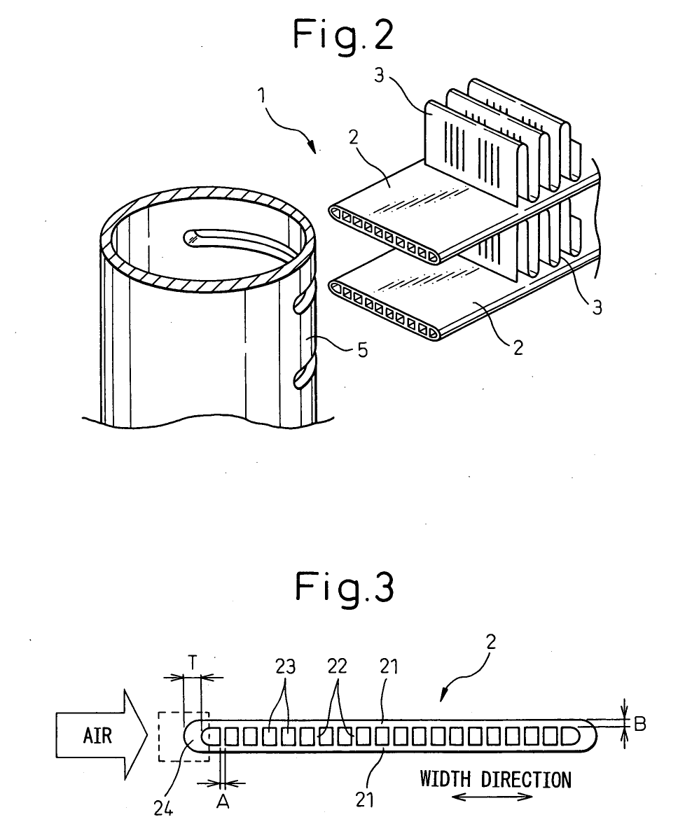

Below, a first embodiment of the present invention (corresponding to the first aspect to 12th aspect and the 16th aspect) will be explained in detail with reference to FIGS. 1 to 16. FIG. 1 is a front view of a heat exchanger 1 according to an embodiment of the present invention, while FIG. 2 is a perspective view showing heat exchanger tubes 2 and a header 5 in the heat exchanger 1 of FIG. 1 disconnected. The heat exchanger 1, as shown in FIG. 1 and FIG. 2, is a heat exchanger called a “multiflow type”.

The heat exchanger 1 is a refrigerant radiator used in a refrigeration cycle of a vehicle air-conditioning system. The refrigerant radiator can also be called a “condenser” or “radiator”. The heat exchanger 1 receives cooling air from outside the vehicle, more preferably receives wind during driving, so is exposed to the outside of the vehicle or is covered with a grille when mounted to the vehicle. For this reason, the heat exchanger 1 is easily struck by foreign matter from outside the vehicle. This striking action of foreign matter is referred to as “chipping”. As a typical example of such foreign matter, pebbles are known. A front side wall part 24 of the tube 2 is the end facing the outside of the vehicle. Therefore, in a typical example, this corresponds to the front, or upwind side, of the vehicle. Further, the front side wall part 24 of the tube 2 sometimes also is oriented toward the bottom or rear side of the vehicle.

This heat exchanger 1 is comprised of a heat exchange part comprised of a large number of heat exchanger tubes (flat multiflow tubes) 2 and corrugated fins 3 alternately stacked in the vertical direction and a pair of headers 4 and 5 arranged at the two sides of this heat exchange part in the horizontal direction and running along the vertical direction. The plurality of heat exchanger tubes 2 are arranged in parallel with their two ends connected to the insides of the headers 4 and 5. The corrugated fins 3 are arranged between the heat exchanger tubes 2 and at the outsides of the outermost heat exchanger tubes 2. Further, side plates 8 are provided at the outsides of the outermost corrugated fins 3. These are all joined together by soldering.

Since the corrugated fins 3 are provided adjoining to heat exchanger tubes 2, only the front end parts of the heat exchanger tubes 2, that is, the front side wall parts 24, are directly exposed to foreign matter flying in from the outside. The front side wall parts 24, in a typical example, are formed as circular or triangular projecting shapes.

Further, not shown partitioning members provided in the header 4 are used to section off the heat exchanger tubes 2. Refrigerant flowing in from an inlet pipe 6 at the top of the header 4 flows from the right to the left in the figure along a first path, flows down inside the header 5, then flows from the left to the right in the figure along a second path, and finally flows out from an outlet pipe 7 at the bottom of the header 4, thereby forming a long flow path. The refrigerant is condensed and liquefied by heat exchange with the outside air while circulating in this way.

FIG. 3 is an end view of a heat exchanger tube 2 according to a first embodiment of the present invention. FIG. 3 is an end view of a rectangular hole type heat exchanger tube 2 and shows its cross-sectional shape. In this embodiment, the fluid circulating holes 23 of the heat exchanger tube 2 are formed as square shapes with rounded corners in cross-sectional shape. These may be called “substantially rectangular” shapes.

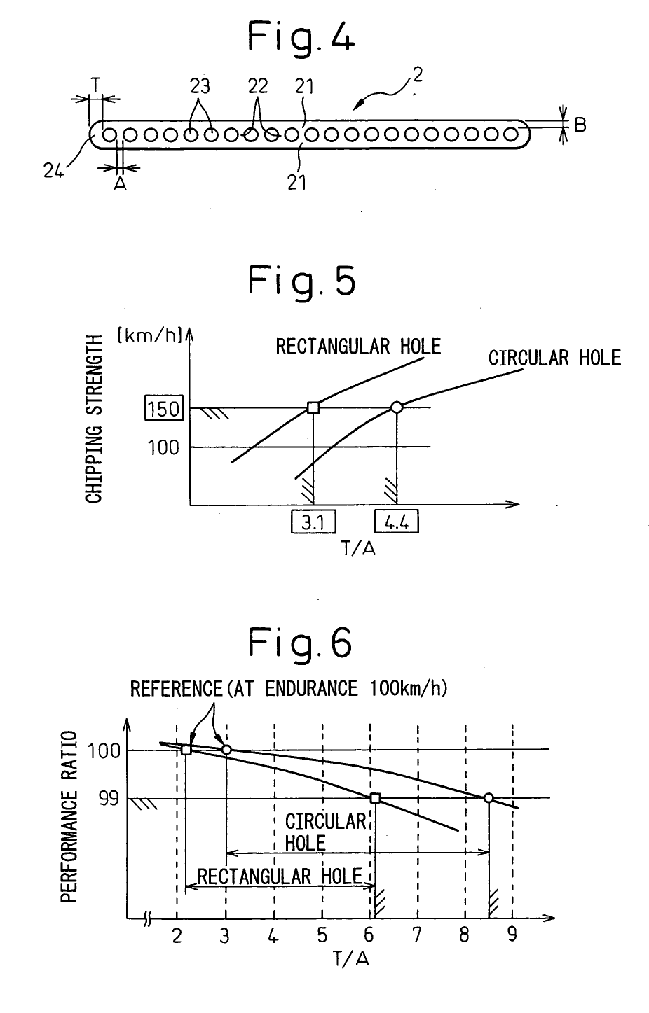

FIG. 4 is an end view of a heat exchanger tube 2 according to a second embodiment of the present invention. FIG. 4 is an end view of a round hole type heat exchanger tube 2 and shows its cross-sectional shape. In this embodiment, the fluid circulating holes 23 of the heat exchanger tube 2 are defined by curved surfaces. These may be called “substantially circular” shapes. “Substantially circular” holes may include, in addition to circular holes, oval holes and elliptical holes.

As the heat exchanger tubes 2 used for the above-mentioned heat exchanger 1, as shown in FIG. 3 and FIG. 4, ones extruded to flat shapes and having insides sectioned off by partition wall parts 22 spanning flat wall parts 21 arranged facing each other to form the peripheral walls of the tube 2 to thereby form a plurality of fluid circulating holes 23 running along the longitudinal direction and arranged in parallel in the width direction of the tube 2 may be used.

Here, investigating the state of destruction of the core parts on the market in the recently increasing incidence of chipping damage to condensers, it was learned that the majority of this was due to damage to only the front ends of the tubes. The dotted line range in FIG. 3 shows the range of chipping. The inventors studied increasing the thickness of the front sides of the tubes to deal with this. However, with just increasing the thickness without any specific plan, the sectional area of the fluid circulating holes 23 cannot be secured and the performance ends up dropping, so the inventors studied the optimum dimension ratio range.

Here, the width direction thickness of the upwind side wall part 24 is designated as “T”, while the thickness of the partition wall parts 22 is designated as “A”. This front end thickness T indicates the thickness in the horizontal direction in the state where the heat exchanger tube 2 is mounted in a vehicle. T contributes to the chipping strength, while A contributes to the performance and pressure resistance. Using that ratio as the parameter (T/A), the inventors measured the chipping strength (impact rate leading to holes) by dropping weights from various heights. The obtained results are shown in FIG. 5. FIG. 5 is a graph showing the relationship of the chipping strength to T/A. The tube used was a typical one with the specifications T: 0.45 mm, A: 0.15 mm.

Next, a target for improvement of the chipping strength was set. From the results of careful investigation of products recovered from the market, it was learned from the destroyed surfaces that a large number of pebbles of about 1 g weight strike a tube. Therefore, the target was set of no destruction at an impact rate of 150 km/h assuming that at high speed driving of 100 km/h, those 1 g or so pebbles fly in at half of that, that is, 50 km/h. The conventional endurance is an impact rate of 100 km/h, so this is a ratio to the conventional value of 1.5.

From the graph of FIG. 5, it is learned that to secure a chipping strength of 150 km/h, a lower limit value of,

in the case of a rectangular hole: T/A=3.1 or more

in the case of a circular hole: T/A=4.4 or more

is necessary.

Next, the inventors determined the upper limit value. FIG. 6 is a graph showing the relationship of performance to T/A. The target for the drop in performance due to thickening was a drop in performance of within 1% based on the current performance. From the graph of FIG. 6, it is learned that to secure a drop in performance of within 1%, an upper limit value of,

in the case of a rectangular hole: T/A=6.1 or less

in the case of a circular hole: T/A=8.5 or less

is necessary.

Summarizing the above findings, to secure a front frontal direction chipping strength of 150 km/h and secure a drop in performance of within 1%, the optimum dimension ratio range between the width direction thickness T of the front side wall part 24 and the thickness A of the partition wall parts 22 is,

in the case of a rectangular hole: 3.1≦T/A≦6.1

in the case of a circular hole: 4.4≦T/A≦8.5.

Next, the inventors studied the optimum dimension ratio range between the width direction thickness T of the front side wall part 24 and the thickness B of the flat wall parts 21 (see FIG. 3). The thickness B of the flat wall parts 21 contributes to the performance and corrosion resistance. If increasing the chipping strength by increasing the width direction thickness T of the front side wall part 24 and correspondingly securing the fluid circulating holes 23 by reducing the thickness B of the flat wall parts 21, conversely the corrosion resistance will be reduced.

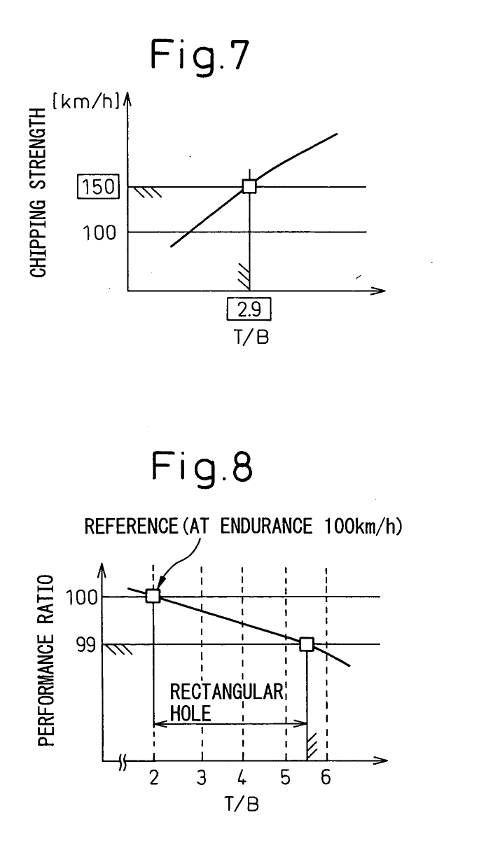

FIG. 7 is a graph showing the relationship of the chipping strength to T/B using T/B as a parameter. From the graph of FIG. 7, it is learned that, in the same way as above, to secure a chipping strength of 150 km/h, a lower limit value of T/B=2.9 or more is required.

Next, the inventors determined the upper limit value. FIG. 8 is a graph showing the relationship of performance to T/B. Here too, the inventors set as a target a drop in performance due to thickening of a drop in performance of within 1% based on the current performance. From the graph of FIG. 8, it is learned that to secure a drop in performance of within 1%, an upper limit value of T/B=5.6 or less is necessary.

Summarizing the above findings, to secure a front frontal direction chipping strength of 150 km/h and secure a drop in performance of within 1%, the optimum dimension ratio range between the width direction thickness T of the front side wall part 24 and the thickness B of the flat wall parts 21 is 2.9≦T/B≦5.6.

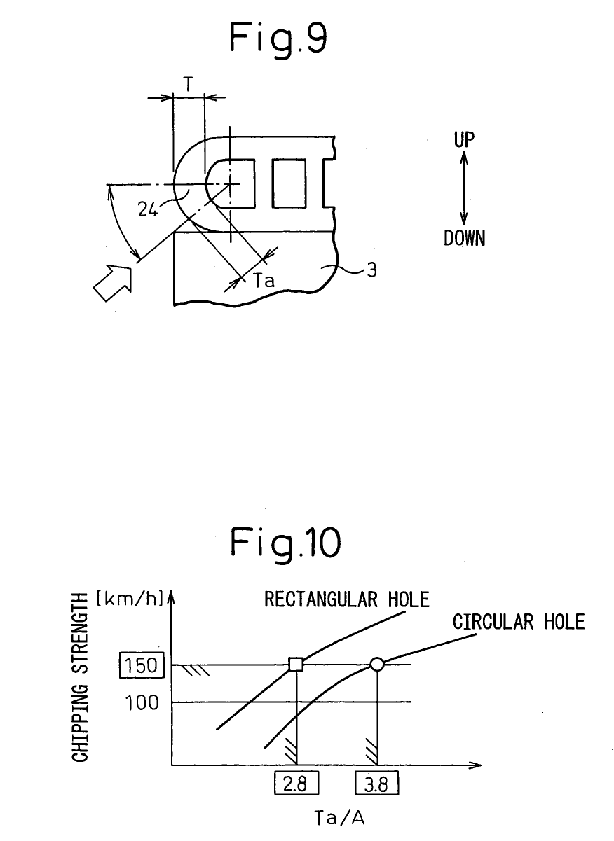

Further, from the results of the above careful investigation of products recovered from the market, as the chipping impact surface, many cases of impact from a downwardly inclined 45 degree direction were observed. FIG. 9 is an explanatory view of an “inclined thickness Ta”. This inclined thickness Ta can also be called the thickness in the downward inclined direction of the front side wall part 24 at the tube 2. This inclined thickness Ta is defined in the state where the heat exchanger tube 2 is set in the vehicle. The inclined thickness Ta can be defined as the thickness on the line connecting the center of the frontmost end fluid circulating hole 23 and the front top corner of the fin 3.

Further, the inclined thickness Ta can be defined as the thickness on the line connecting the intersection of the vertical line passing through the front end of the tube 2 and the horizontal line passing through the bottom surface of the tube 2 and the center of the fluid circulating hole 23. The center of the fluid circulating hole 23 may be defined as the intersection between the center of the fluid circulating hole 23 in the up-down direction and the center in the front-rear direction, that is, the left-right direction in the figure. In a typical example, the front end of the fin 3 matches with the front end of the tube 2.

Further, in another example, the front end of the fin 3 is retracted slightly from the front end of the tube 2. The inclined thickness Ta is then measured at the lower half of the side wall part 24 at the front side of the tube 2 in the range not protected by the fin 3. Further, FIG. 10 is a graph showing the relationship of the chipping strength to Ta/A using as a parameter that Ta/A.

From the graph of FIG. 10, it is learned to secure a chipping strength of 150 km/h, in the case of a rectangular hole: Ta/A=2.8 or more in the case of a circular hole: Ta/A=3.8 or more is necessary.

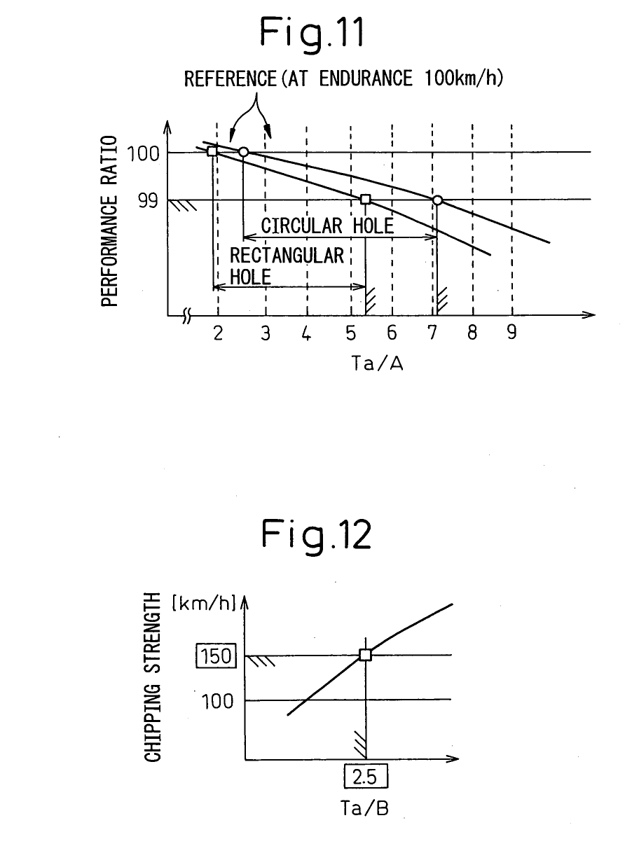

Next, the inventors determined the upper limit value. FIG. 11 is a graph showing the relationship of performance to Ta/A. Here too, the effect of thickening was set to a target of a drop in performance of within 1% based on the current performance. From the graph of FIG. 11, it is learned that to secure a drop in performance of within 1%, an upper limit value of,

in the case of a rectangular hole: Ta/A=5.3 or less

in the case of a circular hole: Ta/A=7.1 or less

is necessary.

Summarizing the above findings, it is learned that to secure a front downward direction chipping strength of 150 km/h and secure a drop in performance of within 1%, the optimum dimension ratio range of the relationship of the inclined thickness Ta of the front side wall part 24 and the thickness A of the partition wall parts 22 is

in the case of a rectangular hole: 2.8≦Ta/A≦5.3

in the case of a circular hole: 3.8≦Ta/A≦7.1.

Further, the optimum dimension ratio range between the inclined thickness Ta of the front side wall part 24 and the thickness B of the flat wall parts 21 can also be found. FIG. 12 is a graph showing the relationship of the chipping strength to the Ta/B using Ta/B as a parameter. From the graph of FIG. 12, in the same way as above, it is learned to secure a chipping strength of 150 km/h, Ta/B=2.5 or more is necessary.

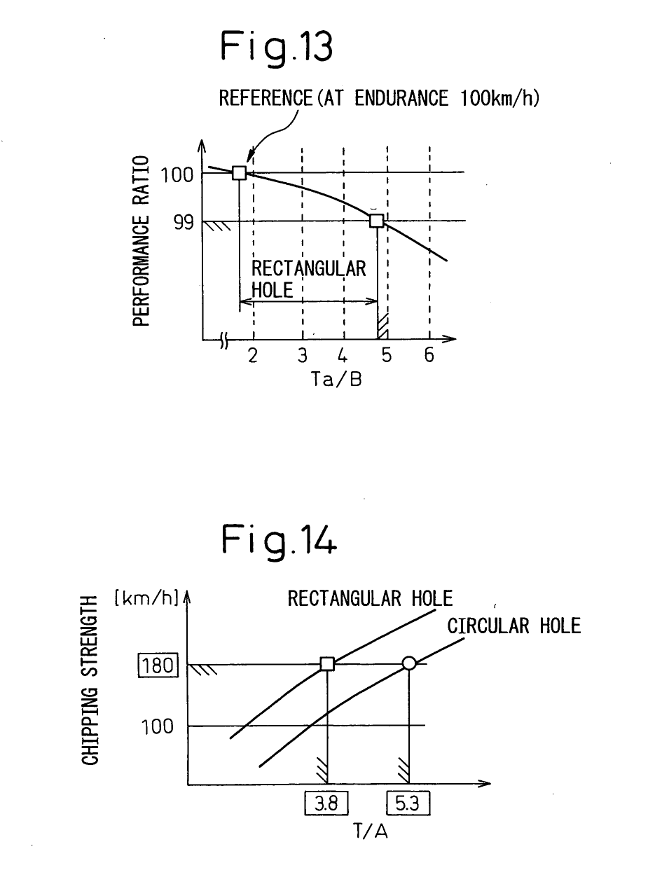

Next, the inventors determined the upper limit value. FIG. 13 is a graph showing the relationship of performance to Ta/B. Here too, the drop in performance due to thickening was set to a target of a drop in performance of within 1% based on the current performance. From the graph of FIG. 13, it is learned that to secure a drop in performance of within 1%, an upper limit value of Ta/B=4.7 or less is required.

Summarizing the above findings, it is learned that to secure a front downward direction chipping strength of 150 km/h and secure a drop in performance of within 1%, the optimum dimension ratio range of the relationship between the inclined thickness Ta of the front side wall part 24 and the thickness B of the flat wall parts 21 is 2.5≦Ta/B≦4.7.

Next, the inventors studied various dimension ratio ranges for securing a chipping strength of 180 km/h giving a further margin of 1.2 for the various dimension ratio ranges for securing a chipping strength of 150 km/h. First, they studied the dimension ratio range between the width direction thickness T of the front side wall part 24 and the thickness A of the partition wall parts 22. FIG. 14 is a graph showing the relationship of the chipping strength to T/A.

From the graph of FIG. 14, it is learned to secure a chipping strength of 180 km/h, the lower limit value has to be raised to in the case of a rectangular hole: T/A=3.8 or more in the case of a circular hole: T/A=5.3 or more.

However, the upper limit value, if targeting a drop in performance of within 1% based on the current performance, as derived from the graph of FIG. 6, remains unchanged as

in the case of a rectangular hole: T/A=6.1 or less

in the case of a circular hole: T/A=8.5 or less.

Summarizing the above findings, it is learned that to secure a front frontal direction chipping strength of 180 km/h and secure a drop in performance of within 1%, the dimension ratio range of the relationship of the width direction thickness T of the front side wall part 24 and the thickness A of the partition wall parts 22 becomes,

in the case of a rectangular hole: 3.8≦T/A≦6.1

in the case of a circular hole: 5.3≦T/A≦8.5.

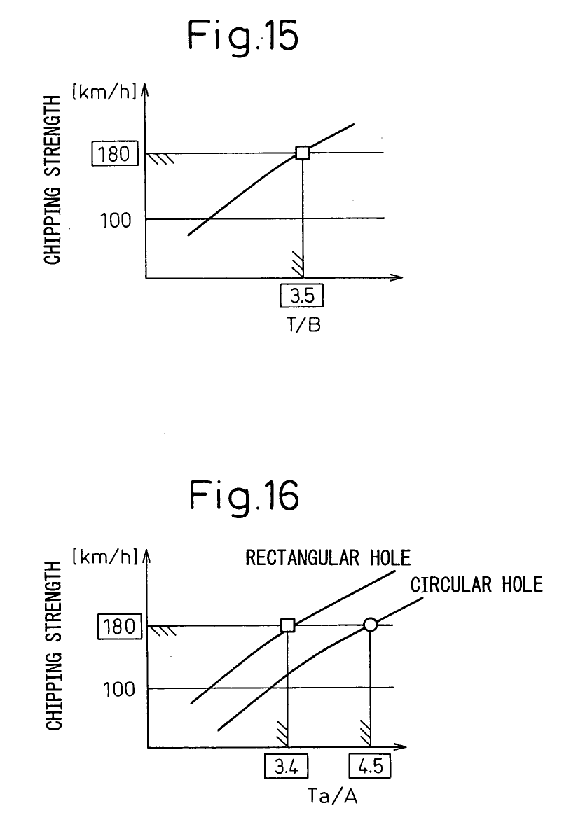

Further, the inventors studied the dimension ratio range for securing a chipping strength of 180 km/h giving a further margin of 1.2 for the dimension ratio range of the width direction thickness T of the front side wall part 24 and the thickness B of the flat wall parts 21. FIG. 15 is a graph showing the relationship of the chipping strength to T/B.

From the graph of FIG. 15, it is learned that to secure a chipping strength of 180 km/h, the lower limit value has to be raised to T/B=3.5 or more.

However, here too, the upper limit value, if targeting a drop in performance of within 1% based on the current performance, as derived from the graph of FIG. 8, remains unchanged as T/B=5.6 or less.

Summarizing the above findings, it is learned that to secure a front frontal direction chipping strength of 180 km/h and secure a drop in performance of within 1%, the dimension ratio range of the relationship between the width direction thickness T of the front side wall part 24 and the thickness B of the flat wall parts 21 becomes 3.5≦T/B≦5.6.

Similarly, the inventors studied the dimension ratio range for the inclined thickness Ta of the front side wall part 24 and the thickness A of the partition wall parts 22. FIG. 16 is a graph showing the relationship of the chipping strength to Ta/A.

From the graph of FIG. 16, it is learned that to secure a chipping strength of 180 km/h, the lower limit value has to be raised to

in the case of a rectangular hole: Ta/A=3.4 or more

in the case of a circular hole: Ta/A=4.5 or more.

However, here too, the upper limit value, if targeting a drop in performance of within 1% based on the current performance, as derived from the graph of FIG. 11, remains unchanged as

in the case of a rectangular hole: Ta/A=5.3 or less

in the case of a circular hole: Ta/A=7.1 or less.

Summarizing the above findings, it is learned that to secure a front downward direction chipping strength of 180 km/h and secure a drop in performance of within 1%, the dimension ratio range of the relationship between the inclined thickness Ta of the front side wall part 24 and the thickness A of the partition wall parts 22 becomes

in the case of a rectangular hole: 3.4≦Ta/A≦5.3

in the case of a circular hole: 4.5≦Ta/A≦7.1.

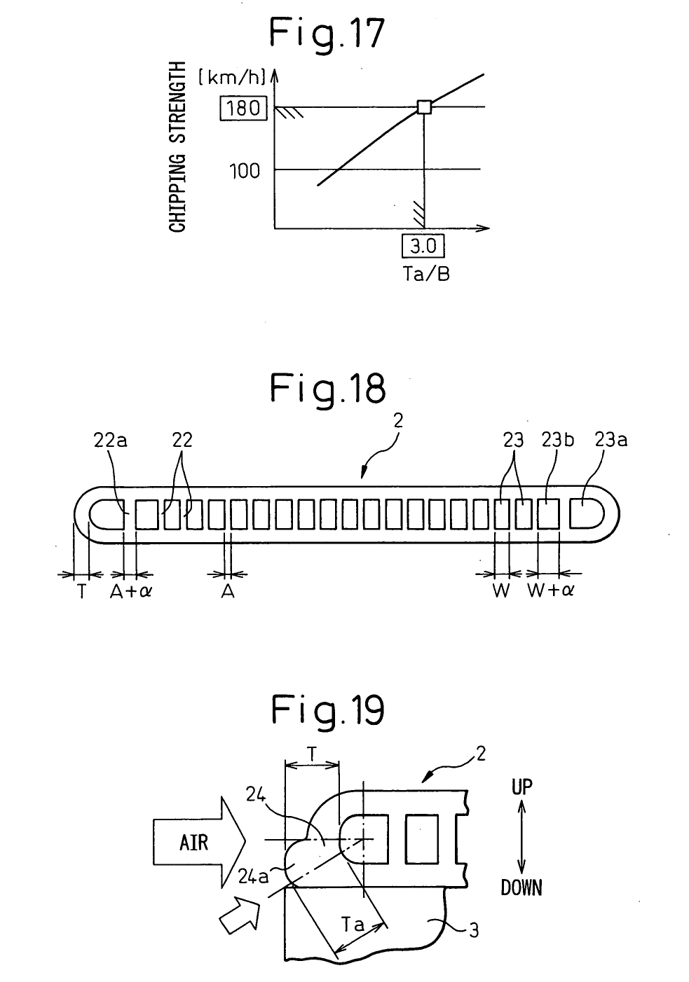

Further, the inventors studied the dimension ratio range for securing a chipping strength of 180 km/h giving a further margin of 1.2 for the dimension ratio range of the inclined thickness Ta of the front side wall part 24 and the thickness B of the flat wall parts 21. FIG. 17 is a graph showing the relationship of the chipping strength to Ta/B.

From the graph of FIG. 17, it is learned that to secure a chipping strength of 180 km/h, the lower limit value has to be raised to Ta/B=3.0 or more.

However, here too, the upper limit value, if targeting a drop in performance of within 1% based on the current performance, as derived from the graph of FIG. 13, remains unchanged as Ta/B=4.7 or less.

Summarizing the above findings, it is learned that to secure a front downward direction chipping strength of 180 km/h and to secure a drop in performance of within 1%, the dimension ratio range of the relationship between the inclined thickness Ta of the front side wall part 24 and the thickness B of the flat wall parts 21 becomes 3.0≦Ta/B≦4.7.

Next, the features and effects of the embodiment will be explained. First, there is provided a heat exchanger tube comprising a flat shaped tube sectioned off inside by partition wall parts 22 spanning flat wall parts 21 arranged facing each other to form peripheral walls of the tube, a plurality of fluid circulating holes 23 running in a longitudinal direction being arranged in parallel in the width direction, air flowing along the outside of the tube in the substantially width direction of the tube and fluid running through the fluid circulating holes 23 exchanging heat, wherein the fluid circulating holes 23 are formed to be substantially rectangular in cross-section and, when a width direction thickness of a front side wall part 24 of the tube is “T” and a thickness of the partition wall parts 22 is “A”, the relationship 3.1≦T/A≦6.1 is made to stand by the shaping process.

According to this, in a rectangular hole tube, it is possible to change the dimensional relationship of the tube while securing performance so as to improve the endurance to chipping from the front frontal direction to 150 km/h (the conventional endurance being 100 km/h, a ratio to the conventional value of 1.5).

Further, in a heat exchanger tube similar to the above, the fluid circulating holes 23 are formed to be substantially circular in cross-section and, when a width direction thickness of a front side wall part 24 of the tube is “T” and a thickness of the partition wall parts 22 is “A”, the relationship 4.4≦T/A≦8.5 is made to stand by the shaping process. According to this, in a circular hole tube, it is possible to change the dimensional relationship of the tube while securing performance so as to improve the endurance to chipping from the front frontal direction to 150 km/h (the conventional endurance being 100 km/h, a ratio to the conventional value of 1.5).

Further, in a heat exchanger tube similar to the above, when a width direction thickness of a front side wall part 24 of the tube is “T” and a thickness of the flat wall parts 21 is “B”, the relationship 2.9≦T/B≦5.6 is made to stand by the shaping process. According to this, it is possible to change the dimensional relationship of the tube while securing performance and corrosion endurance to improve the endurance to chipping from the front frontal direction to 150 km/h (the conventional endurance being 100 km/h, a ratio to the conventional value of 1.5).

Further, in a heat exchanger tube similar to the above, the fluid circulating holes 23 are formed to be substantially rectangular in cross-section, and, when a thickness in a downward inclined direction of a front side wall part 24 of the tube is “Ta” and a thickness of the partition wall parts 22 is “A”, the relationship 2.8≦Ta/A≦5 is made to stand by the shaping process.

According to this, in a rectangular hole tube, it is possible to change the dimensional relationship of the tube while securing performance so as to improve the endurance to chipping from the front downward direction to 150 km/h (the conventional endurance being 100 km/h, a ratio to the conventional value of 1.5).

Further, in a heat exchanger tube similar to the above, the fluid circulating holes 23 are formed to be substantially circular in cross-section and, when a thickness in a downward inclined direction of a front side wall part 24 of the tube is “Ta” and a thickness of the partition wall parts 22 is “A”, the relationship 3.8≦Ta/A≦7.1 is made to stand by the shaping process.

According to this, in a circular hole tube, it is possible to change the dimensional relationship of the tube while securing performance so as to improve the endurance to chipping from the front downward direction to 150 km/h (the conventional endurance being 100 km/h, a ratio to the conventional value of 1.5).

Further, in a heat exchanger tube similar to the above, when designating the inclined thickness of the front side wall part 24 of the tube as “Ta” and designating the thickness of the flat wall parts 21 as “B”, the relationship of 2.5≦Ta/B≦4.7 is made to stand by the shaping process. According to this, it is possible to change the dimensional relationship of the tube while securing performance and corrosion endurance to improve the endurance to chipping from the front downward direction to 150 km/h (the conventional endurance being 100 km/h, a ratio to the conventional value of 1.5).

Further, in a heat exchanger tube similar to the above, when designating the width direction thickness of the front side wall part 24 as “T” and designating the thickness of the partition wall parts 22 as “A”, the relationship of 3.8≦T/A≦6.1 is made to stand by the shaping process. According to this, in a rectangular hole tube, it is possible to change the dimensional relationship of the tube while securing performance so as to improve the endurance to chipping from the front frontal direction to 180 km/h (a further 1.2 times the above aspect of the invention, the conventional endurance being 100 km/h, a ratio to the conventional value of 1.8).

Further, in a heat exchanger tube similar to the above, when designating the width direction thickness of the front side wall part 24 as “T” and designating the thickness of the partition wall parts 22 as “A”, the relationship of 5.3≦T/A≦8.5 is made to stand by the shaping process. According to this, in a circular hole tube, it is possible to change the dimensional relationship of the tube while securing performance so as to improve the endurance to chipping from the front frontal direction to 180 km/h (a further 1.2 times the above aspect of the invention, the conventional endurance being 100 km/h, a ratio to the conventional value of 1.8).

Further, in a heat exchanger tube similar to the above, when designating the width direction thickness of the front side wall part 24 as “T” and designating the thickness of the flat wall parts 21 as “B”, the relationship of 3.5≦T/B≦5.6 is made to stand by the shaping process. According to this, it is possible to change the dimensional relationship of the tube while securing performance and corrosion resistance to improve the endurance to chipping from the front frontal direction to 180 km/h (a further 1.2 times the above aspect of the invention, the conventional endurance being 100 km/h, a ratio to the conventional value of 1.8).

Further, in a heat exchanger tube similar to the above, when designating the inclined thickness of the front side wall part 24 as “Ta” and designating the thickness of the partition wall parts 22 as “A”, the relationship 3.4≦Ta/A≦5.3 is made to stand by the shaping process. According to this, in a rectangular hole tube, it is possible to change the dimensional relationship of the tube while securing performance so as to improve the endurance to chipping from the front downward direction to 180 km/h (a further 1.2 times the above aspect of the invention, the conventional endurance being 100 km/h, a ratio to the conventional value of 1.8).

Further, in a heat exchanger tube similar to the above, when designating the inclined thickness of the front side wall part 24 as “Ta” and designating the thickness of the partition wall parts 22 as “A”, the relationship 4.5≦Ta/A≦7.1 is made to stand by the shaping process. According to this, in a circular hole tube, it is possible to change the dimensional relationship of the tube while securing performance so as to improve the endurance to chipping from the front downward direction to 180 km/h (a further 1.2 times the above aspect of the invention, the conventional endurance being 100 km/h, a ratio to the conventional value of 1.8).

Further, in a heat exchanger tube similar to the above, when designating the inclined thickness of the front side wall part 24 as “Ta” and designating the thickness of the flat wall parts 21 as “B”, the relationship of 3.0≦Ta/B≦4.7 is made to stand by the shaping process. According to this, it is possible to change the dimensional relationship of the tube while securing performance and corrosion resistance to improve the endurance to chipping from the front downward direction to 180 km/h (a further 1.2 times the above aspect of the invention, the conventional endurance being 100 km/h, a ratio to the conventional value of 1.8).

Further, the heat exchanger 1 uses the above heat exchanger tubes 2 and is mounted near a front end face of a vehicle. According to this, it is possible to change the tube end shape and dimensional relationship while securing performance so as to provide a heat exchanger improved in the endurance to chipping from the front direction. It is possible to have the portion of the front side wall part 24 of the tube 2 from the front end to the bottom half not covered by the fin 3 be configured to satisfy the above dimensional conditions.

### Second Embodiment

FIG. 18 is an end view of a heat exchanger tube 2 in a second embodiment of the present invention (corresponding to aspects 13, 14). The characterizing parts different from the above embodiment will be explained. In this embodiment, the thickness “A” of the partition wall parts 22 is changed to become successively smaller from the two ends in the width direction toward the inside. In the example of FIG. 18, the thickness of the partition wall part 22a at the left end in the width direction is thicker by exactly a predetermined amount from the thickness A of the general partition wall parts 22 at the inside.

Alternatively, the width direction hole width or hole diameter of the fluid circulating holes 23 is changed to become successively smaller from the two ends in the width direction toward the inside. In the example of FIG. 18, the fluid circulating hole 23a at the right end of the width direction is the widest and the one further inside fluid circulating hole 23b is wider by exactly a predetermined amount than the width w of the other general fluid circulating holes 23.

According to these, when extruding this flat multiflow tube, the improvement in rigidity of the comb teeth leads to a prolongation of the life of the multiflow tube extrusion die and prevents deformation in the comb teeth and thereby enables a multiflow tube satisfactory in required dimensions and precision to be obtained.

### Third Embodiment

FIG. 19 is a partial end view of a heat exchanger tube 2 in a third embodiment of the present invention (corresponding to the 15th aspect). The characterizing parts different from the above embodiment will be explained. In this embodiment, a projection 24a is formed at the bottom part of the front side wall part 24. According to this, it is possible to change the tube end shape and dimensional relationship while securing performance so as to improve the endurance to chipping from the front downward direction. Note that the projection 24a may be formed at the substantial center of the heat exchanger tube 2 in the thickness direction.

### Other Embodiments

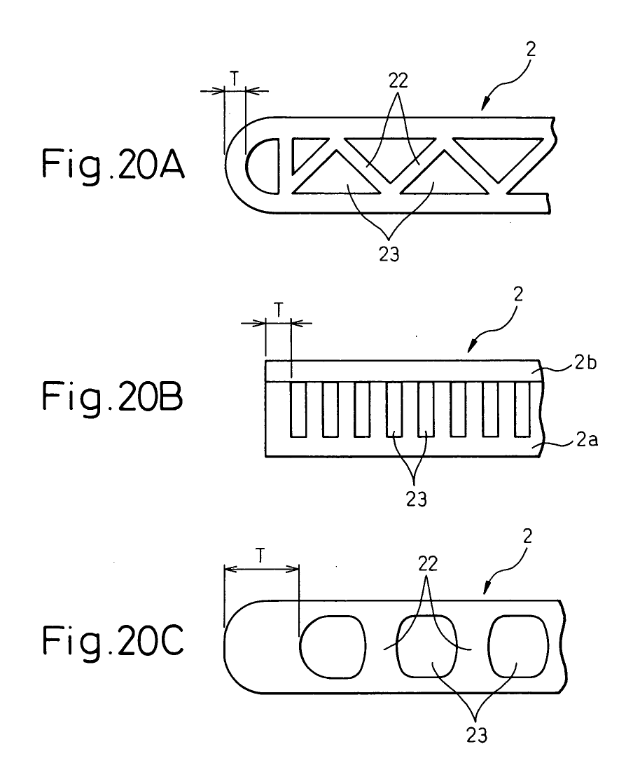

FIG. 20A, FIG. 20B and FIG. 20C are end views of modifications of the heat exchanger tube 2 of the present invention. FIG. 20A shows a triangular hole type, FIG. 20B shows a joined plate type, and FIG. 20C shows an intermediate type between a rectangular hole and a circular hole type where the corners and the partition wall parts 22 are given large R's. In the above embodiments, rectangular hole type and circular hole type heat exchanger tubes 2 were explained, but the present invention is not limited to the above embodiments. So long as the above relationships are satisfied, it may also be applied to a triangular hole type inner fin tube, a joined plate type tube comprised of a plate 2a formed with a large number of grooves covered by a plate 2b so as to form fluid circulating holes 23, or an intermediate type tube between a rectangular hole and circular hole type tube. Further, the fluid circulating through the tube may be a refrigerant, water, oil, etc.

While the invention has been described by reference to specific embodiments chosen for the purposes of illustration, it should be apparent that numerous modifications could be made thereto by those skilled in the art without departing from the basic concept and scope of the invention.

1. A heat exchanger tube comprising a flat shaped tube sectioned off inside by partition wall parts spanning flat wall parts arranged facing each other to form peripheral walls of said tube, a plurality of fluid circulating holes running in a longitudinal direction being arranged in parallel in the width direction, air flowing along the outside of said tube in the substantially width direction of said tube and fluid running through the fluid circulating holes exchanging heat, wherein
the fluid circulating holes are formed to be substantially rectangular in cross-section and, when a width direction thickness of a front side wall part of the tube is “T” and a thickness of the partition wall parts is “A”, the relationship 3.1≦T/A≦6.1 is made to stand by the shaping process.

2. A heat exchanger tube comprising a flat shaped tube sectioned off inside by partition wall parts spanning flat wall parts arranged facing each other to form peripheral walls of said tube, a plurality of fluid circulating holes running in a longitudinal direction being arranged in parallel in the width direction, air flowing along the outside of said tube in the substantially width direction of said tube and fluid running through the fluid circulating holes exchanging heat, wherein
the fluid circulating holes are formed to be substantially circular in cross-section and, when a width direction thickness of a front side wall part of said tube is “T” and a thickness of the partition wall parts is “A”, the relationship 4.4≦T/A≦8.5 is made to stand by the shaping process.

3. A heat exchanger tube comprising a flat shaped tube sectioned off inside by partition wall parts spanning flat wall parts arranged facing each other to form peripheral walls of said tube, a plurality of fluid circulating holes running in a longitudinal direction being arranged in parallel in the width direction, air flowing along the outside of said tube in the substantially width direction of said tube and fluid running through the fluid circulating holes exchanging heat, wherein
when a width direction thickness of a front side wall part of said tube is “T” and a thickness of the flat wall parts is “B”, the relationship 2.9≦T/B≦5.6 is made to stand by the shaping process.

4. A heat exchanger tube comprising a flat shaped tube sectioned off inside by partition wall parts spanning flat wall parts arranged facing each other to form peripheral walls of said tube, a plurality of fluid circulating holes running in a longitudinal direction being arranged in parallel in the width direction, air flowing along the outside of said tube in the substantially width direction of said tube and fluid running through the fluid circulating holes exchanging heat, wherein
the fluid circulating holes are formed to be substantially rectangular in cross-section, and, when a thickness in a downward inclined direction of a front side wall part of said tube is “Ta” and a thickness of the partition wall parts is “A”, the relationship 2.8≦Ta/A≦5 is made to stand by the shaping process.

5. A heat exchanger tube comprising a flat shaped tube sectioned off inside by partition wall parts spanning flat wall parts arranged facing each other to form peripheral walls of said tube, a plurality of fluid circulating holes running in a longitudinal direction being arranged in parallel in the width direction, air flowing along the outside of said tube in the substantially width direction of said tube and fluid running through the fluid circulating holes exchanging heat, wherein
the fluid circulating holes are formed to be substantially circular in cross-section and, when a thickness in a downward inclined direction of a front side wall part of said tube is “Ta” and a thickness of the partition wall parts is “A”, the relationship 3.8≦Ta/A≦7.1 is made to stand by the shaping process.

6. A heat exchanger tube comprising a flat shaped tube sectioned off inside by partition wall parts spanning flat wall parts arranged facing each other to form peripheral walls of said tube, a plurality of fluid circulating holes running in a longitudinal direction being arranged in parallel in the width direction, air flowing along the outside of said tube in the substantially width direction of said tube and fluid running through the fluid circulating holes exchanging heat, wherein
when a thickness in a downward inclined direction of a front side wall part of said tube is “Ta” and a thickness of the flat wall parts is “B”, the relationship 2.5≦Ta/B≦4.7 is made to stand by the shaping process.

7. A heat exchanger tube as set forth in claim 1, wherein when a width direction thickness of a front side wall part is “T” and a thickness of the partition wall parts is “A”, the relationship 3.8≦T/A≦6.1 is made to stand by the shaping process.

8. A heat exchanger tube as set forth in claim 2, wherein when a width direction thickness of a front side wall part is “T” and a thickness of the partition wall parts is “A”, the relationship 5.3≦T/A≦8.5 is made to stand by the shaping process.

9. A heat exchanger tube as set forth in claim 3, wherein
when a width direction thickness of a front side wall part is “T” and a thickness of the flat wall parts is “B”, the relationship 3.5≦T/B≦5.6 is made to stand by the shaping process.

10. A heat exchanger tube as set forth in claim 4, wherein when a downward inclined direction thickness of a front side wall part is “Ta” and a thickness of the partition wall parts is “A”, the relationship 3.4≦Ta/A≦5.3 is made to stand by the shaping process.

11. A heat exchanger tube as set forth in claim 5, wherein when a downward inclined direction thickness of a front side wall part is “Ta” and a thickness of the partition wall parts is “A”, the relationship 4.5≦Ta/A≦7.1 is made to stand by the shaping process.

12. A heat exchanger tube as set forth in claim 6, wherein
when a downward inclined direction thickness of a front side wall part is “Ta” and a thickness of the flat wall parts is “B”, the relationship 3.0≦Ta/B≦4.7 is made to stand by the shaping process.

13. A heat exchanger tube as set forth in claim 1, wherein the thickness “A” of the partition wall parts is changed to successively become smaller from the two ends in the width direction toward the inside.

14. A heat exchanger tube as set forth in claim 1, wherein said fluid circulating holes have a width direction hole width or hole diameter changed to successively become smaller from the two ends in the width direction toward the inside.

15. A heat exchanger tube as set forth in claim 1, wherein a projection is formed at the bottom part of the front side wall part.

16. A heat exchanger using heat exchanger tubes as set forth in claim 1 stacked in the thickness direction and mounted near a front end face of a vehicle.
